(19) United States
(12) Patent Application Publication
(10) Pub. No.: US 2017/0104705 A1
(43) Pub. Date: Apr. 13, 2017

(54) METHOD AND APPARATUS FOR DATABASE ACCESS CONTROLS TO PROVIDE PRIVILEGED ACCESS TO PRIVATE MESSAGES TO PROTECT DATA FROM UNAUTHORIZED DISCLOSURE

(71) Applicant: Criptext, Inc., New York, NY (US)

(72) Inventor: Mayer MIZRACHI, New York, NY (US)

(21) Appl. No.: 14/882,136

(22) Filed: Oct. 13, 2015

(51) Int. Cl. H04L 12/58; G06F 21/62; H04L 29/06

(52) U.S. Cl. CPC H04L 51/08; H04L 51/12; H04L 63/10; G06F 21/6218

(57) ABSTRACT

Some embodiments described herein relate to a method that can include receiving a portion of a message from a sender device. A request to access the portion of the message can then be received from a recipient device. In response to receiving the request to access the portion of the message, a communication channel can be established to provide access to the portion of the message while the recipient device sends an indication that a predefined input is continuously supplied.

### CROSS-REFERENCE TO RELATED APPLICATIONS

This application is related to a U.S. patent application having the attorney docket number CRIP-002/00US 324720-2002, filed Oct. 13, 2015, entitled “Methods and Apparatus for Communicating Private Messages with Partially Obscured Content to Limit or Prevent Unauthorized Use of Data to Impede Privacy Violations,” and U.S. patent application Ser. No. 14/044,833, filed Oct. 2, 2015, entitled, “Method and Apparatus for Improved Private Messaging,” the disclosure of which each is incorporated herein by reference in its entirety.

### BACKGROUND

Some embodiments described herein relate to sending and/or receiving messages containing private information. Access controls are described herein such that privileged access to private messages can be granted. Such privileged access can prevent or impede private data stored in a database from being disclosed without authorization.

The development of email, short message service (SMS) messages, multimedia messaging service (MMS) messages, and other similar modes of communication are ingrained in modern life. Such rapid communication modes are used to communicate everything from the trivial to the mission critical. These known communication modes, however, are built on the premise that the sender trusts the recipient. For example, using known communication methods, it is typically easy to copy, forward, and/or save messages and/or attachments in their entirety.

In some situations, however, security concerns may dictate that the recipient should not be trusted to maintain the confidentiality of sensitive information. A need therefore exists for methods and apparatus for protecting digital documents from being copied.

### SUMMARY

Some embodiments described herein relate to a method that can include receiving a portion of a message from a sender device. A request to access the portion of the message can then be received from a recipient device. In response to receiving the request to access the portion of the message, a communication channel can be established to provide access to the portion of the message while the recipient device sends an indication that a predefined input is continuously supplied.

### BRIEF DESCRIPTION OF THE FIGURES

FIG. 1 is a schematic illustration of a system for communicating private messages, according to an embodiment.

FIG. 2 is a signal diagram illustrating an example of communicating private messages, according to an embodiment.

FIGS. 3A-3C are screenshots of sending and/or receiving digital documents and protecting digital documents from being copied, according to an embodiment.

### DETAILED DESCRIPTION

Some embodiments described herein relate to a method for providing access to private messages or message portions while preventing or impeding the messages or message portions from being copied, forwarded, or saved. The method can include receiving, at an access control server, at least a portion of the message from a sender device, optionally including an indicator that the sender desires the message or message portion be protected from copying, forwarding and/or saving. The access control server can then receive a request to access the message or message portion from a recipient device, for example, in response to the recipient device receiving an email or similar message including an instruction, link, or reference to the message or message portion. In response to receiving the request to access the message, the access control server and the recipient device can collectively establish a communication channel. The communication channel can be a two-way communication channel configured such that while the recipient device sends an indication that a predefined input is supplied, the access control server provides access to the message or message portion. Similarly stated, the message or message portion can be streamed or substantially continuously updated via the communication channel while the recipient device continues to send an indication that the predefined input is continuously supplied. The predefined input can be configured to prevent or impede the user of the recipient device from copying, saving, or forwarding the message or message portion. For example, the predefined input can exclude an input associated with saving the message, such that if the user provides the input associated with saving the message, the communication channel can be closed or otherwise cease providing access to the message or message portion.

Some embodiments described herein relate to a method of composing and/or sending a message having a private portion, such as a content portion or attachment. A user of a sender device can compose the message via a general purpose messaging client, such as an email client or webmail interface. In some instances, the general purpose messaging client can include one or more extensions or plug-ins operable to divide the message and/or interact with an application programing interface (API) associated with an access control server and/or messaging server. In other instances, a standard general purpose messaging client (e.g., without additional extensions) can be used to compose and/or send a message, for example, by addressing the message (including the private portion) to the access control server and/or interacting with a web or other suitable portal associated with the access control server. The user of the sender device can define an access control for the content portion of the message such that the access control server prevents or impedes the copying, saving, and/or forwarding of the content portion of the message. The user device can then send a signal representing the content portion of the message and the access control to the access control server. In response, the access control server and a recipient device can collectively establish a communication channel such that the recipient device is provided access to the content portion of the message while the recipient device sends an indication that a predefined input is continuously supplied.

Some embodiments described herein relate to a method of receiving a portion of a message protected by access controls configured to prevent or impede copying, saving, and/or forwarding of the portion of the message. A user of a recipient device can receive a general purpose message, such as an email, via communication server, such as an email server. The communication server may not be operable to enforce access controls. That is, the communication server may implement, for example, the standardized post office protocol (e.g., POP3), internet message access protocol (e.g., IMAP), and/or simple mail transfer protocol (SMTP). The general purpose message can include a link (e.g., hyperlink), reference, or instruction to access the portion of the message protected by access controls from an access control server. For example, the general purpose message can include a link or embedded iframe configured to direct the messaging client to the access control server. The recipient device can execute (on a processor) the instruction such that the recipient device and the access control server collectively establish a communication channel. The communication channel can be configured such that access to the portion of the message protected by access controls is provided while the recipient device sends an indication that a predefined input is continuously suppled. For example, the user of the recipient device can be prompted to press a combination of keys that prevents or inhibits the user from saving, copying, or forwarding the portion of the message while the keys are pressed. If the user ceases to press the predefined keys and/or presses an additional key, the communication channel can be closed or access to the portion of the message protected by access controls can otherwise be revoked temporarily (e.g., until the user again supplies the predefined input) or permanently. In some instances, the portion of the message protected by access controls can be presented such that it obscures some or all of the general purpose message. In this way, the portion of the message protected by access controls, which may not include an indication of the sender, is not be presented by the recipient device simultaneously with the general purpose message, which may include, for example, an indication of the sender.

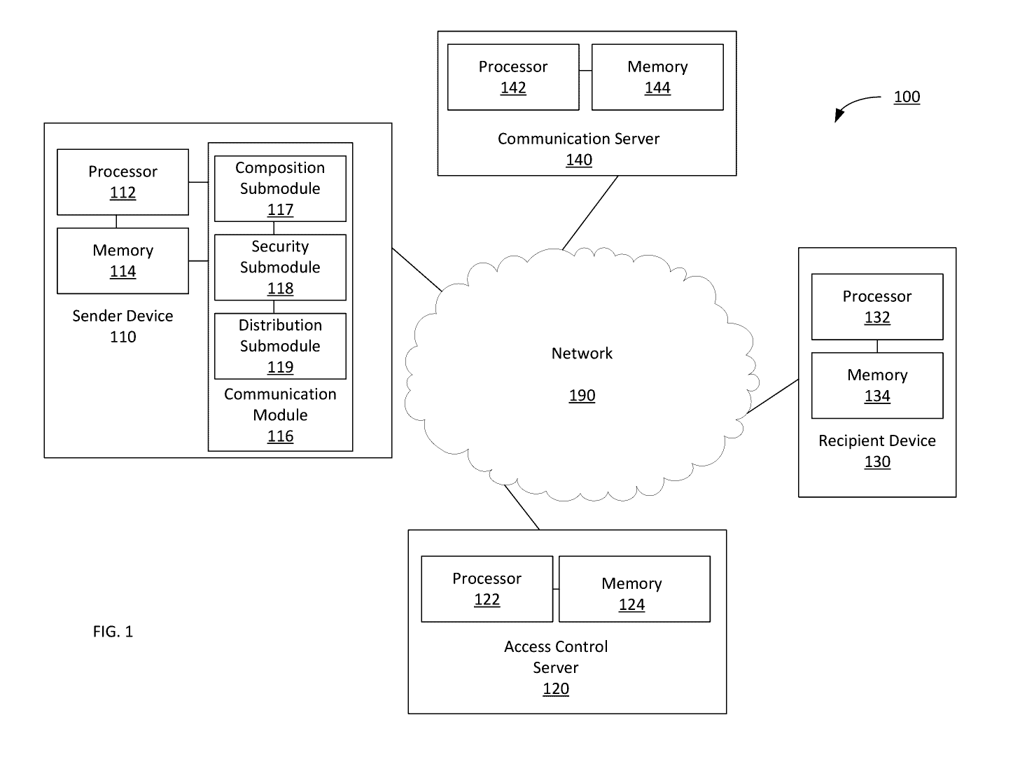

FIG. 1 is a schematic illustration of a system 100 for communicating private messages, according to an embodiment. The system 100 includes a sender device 110, an access control server 120, a communication server 140, and a recipient device 130 communicatively coupled via a network 190. The network 190 can be, for example, the Internet, an intranet, a local area network (LAN), a wide area network (WAN), a virtual network, a telecommunications network, any other suitable communication system and/or combination of such networks. The network 190 can be implemented as a wired and/or wireless network.

The communication server 140 can be any suitable computing entity to facilitate communication between other computing entities, such as the sender device 110 and the recipient device 130. For example, the communication server 140 can be an email or other messaging server.

The communications server 140 includes a processor 142 and a memory 144. The processor 142 can be, for example, a general purpose processor, a Field Programmable Gate Array (FPGA), an Application Specific Integrated Circuit (ASIC), a Digital Signal Processor (DSP), and/or the like. The processor 142 can be configured to retrieve data from and/or write data to memory, e.g., the memory 144, which can be, for example, random access memory (RAM), memory buffers, hard drives, databases, erasable programmable read only memory (EPROMs), electrically erasable programmable read only memory (EEPROMs), read only memory (ROM), flash memory, hard disks, floppy disks, cloud storage, and/or so forth.

The access control server 120 can be any suitable computing entity, such as a webserver. The access control server 120 includes a processor 122 and a memory 124, which can be structurally and/or functionally similar to the processor 142 and/or the memory 144, respectively. In some instances, the communication server 140 may be a third party device relative to the access control server 120. That is, the communication server 140 may not be under the control and/or ownership of an operator of the access control server 120.

In some instances, the access control server 120 can be operable to receive a message or a portion of a message from the sender device 110 via the network 190. The message or portion of the message can be received in a single transmission or data packet, or in multiple transmissions or data packets. For example, the access control server 120 can be operable to receive one data packet (or set of data packets) containing the message content and/or an attachment (optionally without any information identifying the sender device 110 and/or the user of the sender device 110), and a second data packet (or set of data packets) containing information identifying the sender device 110 and/or the user of the sender device 110 (optionally without any information associated with message content).

The access control server 120 can be operable to provide and control access of the message or portion of the message such that a recipient (e.g., a user of the recipient device 130) can receive the message or portion of the message while access controls are enforced. In this way, the access control server 120 can act as an intermediary between the sender device 110 and the recipient device 130 such that the recipient device 130 does not receive data directly from the sender device 110 or the communication server 140. Such an intermediary (access control server 120) can enable an initial communication via a general purpose communication channel, such as email, via the communication server 140, while providing access controls not typically available via general purpose communication channels. For example, as discussed in further detail herein, the access control server 120 can “stream” the message or portion of the message, for example, by providing access to the message content and/or the identity of the sender using an iframe or similar suitable technique. Such an iframe can be automatically refreshed, for example, every 30 seconds, every 10 seconds, every second, etc. An automatic refresh of an iframe (or similar streaming presentation) every 3 seconds or less is referred to herein as “substantially continuous.” By substantially continuously refreshing the message or portion of the message, the access control server 120 can be operable to revoke access to the message or portion of the message, for example, by refreshing to a blank screen or filler content.

The sender device 110 can be a computing entity, such as a smartphone, a laptop computer, a desktop computer, etc. The sender device 110 includes a processor 112, a memory 114, and a communication module 116. The processor 112 and/or the memory 114 can be structurally similar to the processor 142 and/or memory 144, described above. The communication module 116 can be hardware and/or software (stored in the memory 114 and/or executing on the processor 112) operable to enable a user of the sender device 110 to compose, send, and/or control the distribution of messages. The communication module 116 includes a composition submodule 117, a security submodule 118, and a distribution submodule 119.

The composition submodule 117 can be any suitable hardware and/or software (e.g., stored in memory and/or executing on a processor) operable to enable the user of the sender device 110 to compose a message. For example, the composition submodule 117 can be or include an email client and/or web browser (stored in memory 114 and/or executing on the processor 112) operable to draft emails and/or attach files. The composition submodule 117 can be operable to receive signals from an input device or component (not shown) such as a hardware and/or virtual keyboard, touchscreen, mouse, microphone, etc. Furthermore, the composition submodule 117 can be operable to retrieve data, such as documents, pictures, videos, files, etc. from local and/or remote memory for inclusion in the message. The composition submodule 117 can be operable to construct, format, locally store (e.g., in memory 114), and/or otherwise translate signals received from the input device into a form capable of transmission to other computing entities such as the server 120 and/or the recipient device 130. The composition submodule 117 can be communicatively coupled to the security submodule 118.

The security submodule 118 can be operably coupled to a network module (not shown) such as a network interface controller (NIC), Bluetooth® module, and/or any other suitable hardware and/or software (stored in memory and/or executing on a processor) operable to communicatively couple the sender device 110 to the network 190 and/or any other suitable computing entity.

In some instances, the security submodule 118 can be operable to cause the network module to send information associated with a first portion of a message to the access control server 120 and to cause the network module to send information associated with a second portion of the message to the communication server 140. The first portion of the message can be the body or content portion of the message and/or an attachment. The second portion of the message can be message metadata, such as email header data and/or a link or instruction to retrieve the first part of the message from the access control server 120. In this way, as described in further detail herein, the first portion of the message can be delivered to the recipient device 130 via email or other widely used and supported communication mode via the communication server 140. The first portion of the message can include an instruction, link, or reference to the second portion of the message such that the recipient device can access the second portion of the message via the access control server 120.

In other instances, the security submodule 118 can be operable to cause the network module to send information associated with the entire message, optionally divided into one or more portions, to the access control server 120. As described in further detail herein, the access control server 120 can be operable to deliver a first portion of the message, including an instruction, hyperlink, or reference to a second portion of the message, to the recipient device 130 via the communication server 140 such that the recipient device 130 can retrieve the second portion of the message from the access control server 120. The recipient device 130 can retrieve the second portion of the message from the access control server 120 based on the instruction, hyperlink, or reference (e.g., by selecting or activating the hyperlink).

The security submodule 118 can also be operable to apply cryptographic, permission-based, and/or any other suitable access controls to the message and/or a portion(s) of the message (e.g., and/or information identifying the sender device 110). For example, the security submodule 118 can encrypt the message by applying a public key associated with the access control server 120, a public key associated with an intended recipient (e.g., the user of the recipient device 130), and/or any other suitable technique. For example, the security submodule 118 can be operable to encrypt the message a first time using a public key associated with an intended recipient and then, after the message has been encrypted once, encrypt the message a second time using a public key associated with the access control server 120. In this way, retrieving the contents of the message may entail first decrypting using a private key associated with the access control server 120 and subsequently using a private key associated with the intended recipient to decrypt the message a second time. Such serial encryption can prevent users associated with the access control server 120 from decrypting the contents of the message while simultaneously preventing out-of-band exchange of the contents of the message, such that the user of the sender device 110 can restrict the exchange of the contents of the message to a communications channel including the access control server 120. In other words, neither the access control server 120 nor the intended recipient can alone access the contents of the message.

The security submodule 118 can be communicatively coupled to the distribution module 119. The distribution submodule 119 can be operable to coordinate with the access control server 120 and/or the communication server 140 to control the distribution of messages. In some instances, the distribution submodule 119 can be operable to cause messages or portions of the message intended for recipient device 130, such as a content portion or attachment, to be routed to the access control server 120 such that the recipient device 130 can receive the message or portion of the message (e.g., content portion or attachment) from the access control server 120. The distribution submodule 119 can further be operable to cause messages or portions of the message to be routed to the communication server 140. For example, the distribution module 119 can format an email or similar message to be delivered to the recipient device 130 via the communication server 140, which may be an email server. The email can include an instruction, hyperlink, or reference operable to enable the recipient device 130 to access another portion of the message (e.g., a content portion or attachment) from the access control server 120. The recipient device 130 can retrieve the second portion of the message from the access control server 120 based on the instruction, hyperlink, or reference (e.g., by selecting or activating the hyperlink).

The distribution submodule 119 can be operable to cause the network module to transmit information associated with a portion of the message (e.g., a content portion and/or attachment) in one data packet (or one set of data packets), and information associated with the sender device 110 and/or the user of the sender device 110, such as real name, username, pseudonym, return address, a public key associated with the sender device 110, internet protocol (IP) address of the sender device 110, etc., in a second, different, data packet (or second set of data packets). In such an instance, no single data packet (or one set of data packets) includes both content information and information identifying the sender. Thus, interception of one packet (or one set of data packets) includes insufficient data to identify both the contents of a message and the sender of the message.

The distribution submodule 119 can be operable to issue commands, make calls to, and/or otherwise interact with an application programming interface (API) implemented by the access control server 120. The distribution submodule 119 can be operable to indicate the distribution of the message (e.g., specify intended recipient(s) such as the user of the recipient device 130); set conditions for forwarding, copying, capturing a screenshot of the message, etc.; specify a blacklist of recipients that do not have permission to access the message; specify anonymity conditions, such as indicating that the message be sent without specifying the sender; indicating the message be restricted from being displayed simultaneously with the sender information; indicating that the message may be displayed with the sender information; set an expiration time for messages; request delivery notifications; recall previously sent messages; and/or so forth. In response, the access control server 120 can be operable to enforce such access controls, for example, by verifying user credentials before providing access to the message (or message portion).

The recipient device 130 can be any suitable computing entity, such as a desktop computer, a laptop computer, a cellular telephone, etc. The recipient device 130 includes a processor 132 and a memory 134, which can be structurally and/or functionally similar to the processor 112 and/or the memory 114, respectively. The recipient device 130 can be operable to receive and/or retrieve a message from the communication server 140. For example, an email client or other suitable messaging client (executing on the processor 132 and/or stored in the memory 134) can be operable to receive a push message or pull message (or message portion) from the communication server 140.

As described in further detail herein, in some embodiments the recipient device 130 (optionally in conjunction with the access control server 120) can be configured such that the message (or message portion) is only displayed under conditions that prevent or impede message copying, forwarding, or saving. In some instances a portion of the message, such as a content portion or attachment is displayed during a time period that is mutually exclusive from a time period during which another portion of the message (e.g., a portion received from the communication server 140) is displayed. In this way, a portion of the message received via the access control server 120 (e.g., a content portion of the message and/or attachment) can be presented without information received from the communication server 140 (e.g., an email header and/or body optionally identifying the sender). Thus, if a portion of the message is captured (e.g., saved or captured via a screenshot functionality) the sender may retain plausible deniability that the sender was not the author of the message if the sender's identity is not simultaneously presented with the message content.

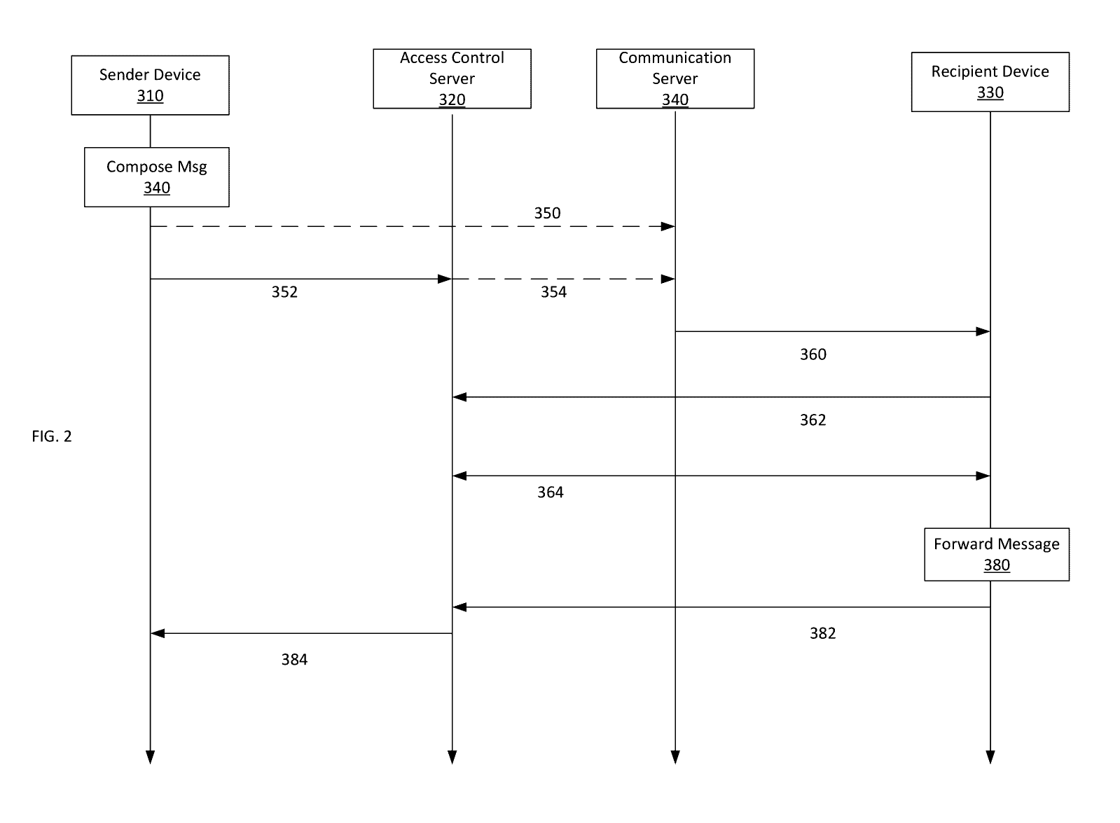

FIG. 2 is a signal diagram illustrating an example of communicating private messages, according to an embodiment. The example shown in FIG. 2 includes a sender device 310, an access control sever 320, a communication server 340, and a recipient device 330, each of which can be structurally and/or functionally similar to the sender device 110, the access control server 120, the communication server 140, and the recipient device 130, respectively, as shown and described above with reference to FIG. 1.

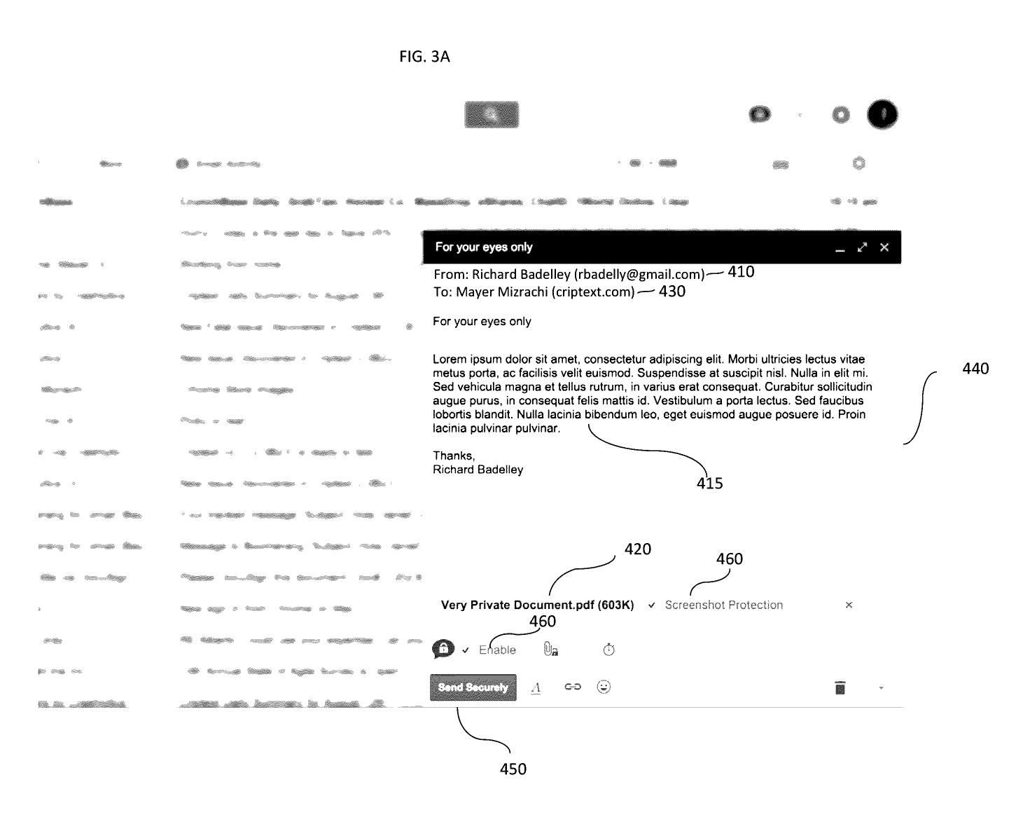

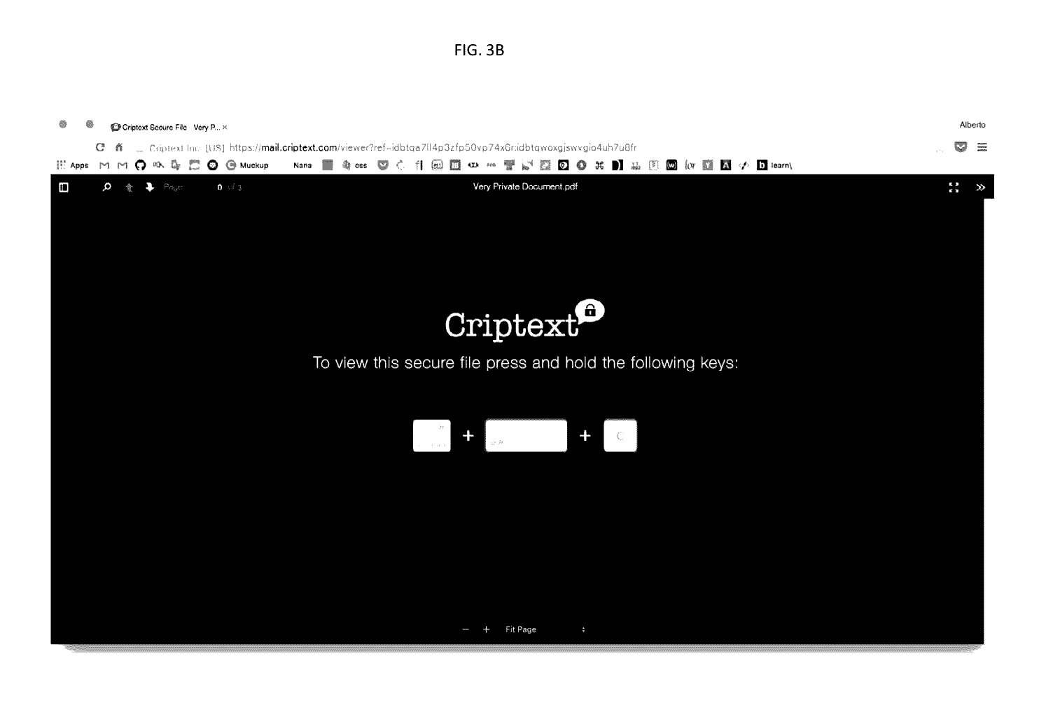

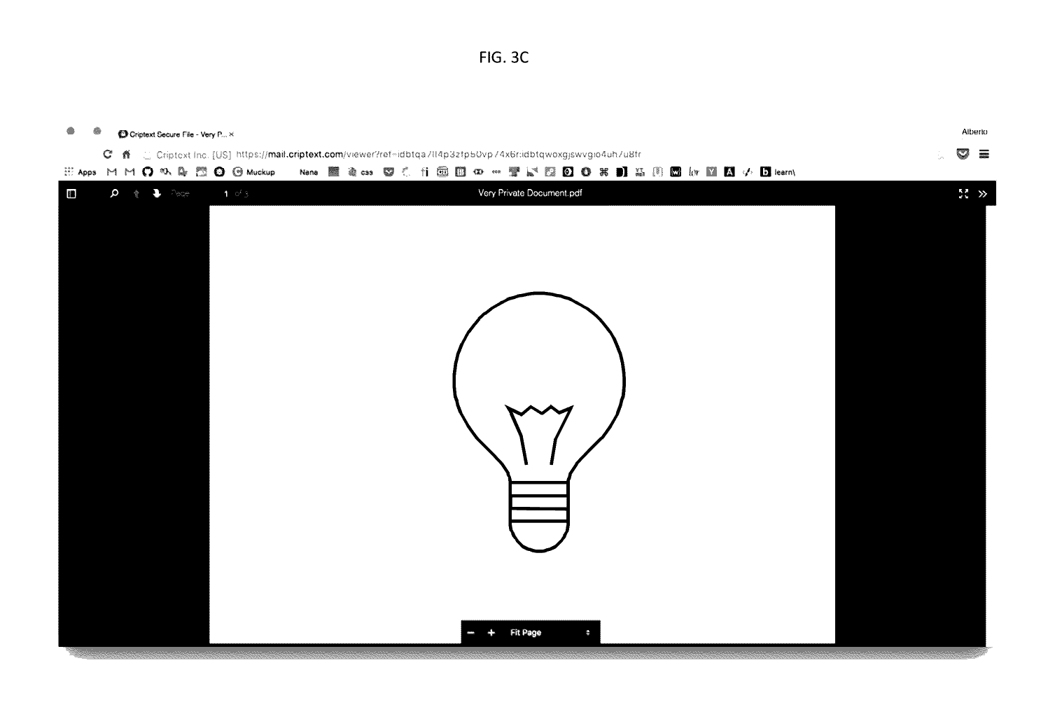

At 340, a message can be composed at the sender device 310. For example, a user of the sender device 310 can type an email, MMS message, select a file (stored in a memory) to be sent, etc. FIG. 3A is a screenshot of an application operable to compose a message 440 at 340, according to an embodiment. In this instance, the application is a web browser application (executing on a processor) operable to compose an email message using Google's® Gmail® webmail interface. The message 440 includes an indication of the sender 410, an indication of the recipient 430, a content portion 415, and an attachment 420.

In some instances, the web browser application can include one or more extensions or plug-ins operable to modify a standard interface associated with a web-based communication mode provided by the messaging server 340 and/or to interact with the access control server 320. For example, the interface can be altered to provide interface elements 460 operable to cause the sender device 310 communicate access controls settings to the access control server 320. As another example, a typical “send” button can be replaced by a “send securely” button 450.

The send securely button 450 can be configured to cause the sender device 310 to send a portion of the message, represented by signal 350 in FIG. 2, to the communication server 340. The send securely button 450 can further be operable to cause the sender device 310 to send another portion of the message, such as the content portion 415 and/or attachment 420 to the access control server 320 via signal 352. Signal 350 can be a standard email containing an instruction, link, or reference to retrieve the content portion 415 and/or the attachment 420 from the access control server 320. The recipient device 330 can receive and/or retrieve signal 360, which represents the message (or message portion) sent to the communication server 340.

In another instance, the send securely button 450 can be operable to cause the sender device 310 to send signal 352 representing the entire message including the intended recipient 410, the content portion 415, and the attachment 420 to the access control server 320 (such that signal 350 is not sent). In such an instance, the access control server 320 can be operable to send signal 354 representing a standard message (e.g., an email) to the communication server 340 including a instruction, link, or reference to retrieve the content portion 415, the attachment 420 and/or an indication of the sender 410 and/or the sender device 310 from the access control server 320. Similarly stated, in such an instance, signal 360 may be devoid of an indication of the sender and/or sender device 310. For example, signal 360 may take the form of an email having an identifier associated with the access control server 320 in the “from:” field.

The access control server 320 can be operable to cooperate with the communication server 340 such that the recipient device 330 receives an indication of an awaiting message via general purpose communication mode, such as email or MMS that is already used by the user of the recipient device 330 (e.g., a commercially available third party email or MMS service or application). That is, the access control server 320 can cooperate with the communication server 340 such that the recipient device 330 may not require specialty software, such as a special-purpose or proprietary application (e.g., a messaging application operable to send and/receive messages only from other users of the messaging application) to receive signal 360. Similarly stated, the recipient device 330 having a general purpose program (stored in memory and/or executing on a processor), such as an email client or web browser, can be operable to receive signal 360.

In some instances, the communication represented by signal 360 can include an embedded iframe or other suitable instruction to direct and/or cause the recipient device 330 to send signal 362 to the access control server 320. Signal 362 can include a request to obtain message contents and/or an indication of the identity of the sender and/or sender device 310. For example, embedded hypertext markup language (HTML) (or code in any suitable language) in signal 360 can cause the processor of the recipient device 330 to send signal 362 to the access control server 320 when the embedded HTML code is executed. Signal 362 can represent a request to retrieve the contents of the message composed at 340.

In response to receiving signal 362, the access control server 320 can send signal 364, representing the contents 415, the attachment 420, and/or the identity of the sender 410 to the recipient device 330. In some instances, the recipient device 330 may be operable to present the contents 415, the attachment 420, and/or the identity of the sender 410 via an iframe or other automatically and/or substantially continuously refreshing means. Similarly stated, signal 364 can represent a communication channel for transmitting the content of the message such that the access control server 320 can be operable cause the recipient device 330 to update, modify, and/or replace the contents of the message with other information, a blank screen, etc. Furthermore, the access control server 320 and the recipient device 330 can be collectively configured such that if the communication channel represented by signal 364 is closed (e.g., if the connection is terminated, lost, an update is not received within a predetermined length of time, the iframe is delinked from a database entry storing the contents 415, the attachment 420, and/or the identity of the sender 410, etc.), the recipient device 330 can cease presenting the contents 415, the attachment 420, and/or the identity of the sender 410. Similarly stated, the access control server 320 and the recipient device 330 can be collectively configured such that if an instruction configured to provide access to the contents 415, the attachment 420, and/or the identity of the sender 410 is disabled, the recipient device's 330 access to the content portion of the message can be revoked.

In some instances, the communication channel represented by signal 364 can require active and/or continuous input from the user of the recipient device 330 to present the contents 415, the attachment 420, and/or the identity of the sender 410. For example, as shown in FIG. 3B the contents of the attachment 420 can be obscured, masked or otherwise not sent or displayed until the user of the recipient device simultaneously presses and holds the command, shift, and C keys. While the user presses and holds the command, shirt, and C keys, the attachment 420 can be displayed, as shown in FIG. 3C. If the user stops holding any of the required keys and/or presses any additional keys, the attachment 420 can again be masked or otherwise not presented, as shown in FIG. 3B. Because saving, copying, forwarding, or otherwise maintaining access to the attachment 420 will typically require specified user input, additional user inputs, such as pressing the “Print Screen” button or accessing a save command can be prevented or impeded by ceasing to present the content of the attachment when an additional input is detected. Thus, the recipient device 330 can stream data associated with user input received via an input device of recipient device 330 to the access control server 320 such that, if the user of the recipient device 330 does not continuously press and hold a predefined user input, access to the contents 415, the attachment 420, and/or the identity of the sender 410 and/or sender device 310 can be revoked.

Furthermore, as shown in FIG. 3C, while the attachment 420 is displayed, additional information associated with the message 440, such as an indication of the sender 410 and/or the content portion 415, may not be displayed. In this way, if an image of the attachment 420 is captured, it may not be explicitly linked to the sender 410 and/or the content portion 415 of message 440 based solely on the information displayed on the recipient device 330.

At 380, the recipient device 330 can attempt to forward the message received with signal 360. For example, in an instance where the communication server 340 is a third party email server, the recipient device 330 can forward an email associated with signal 360. In some instances, the recipient device 330 can be operable to send signal 382 to the access control server 320 reporting the attempt to forward the message at 380. In response, the access control server 320 can notify the sender device 310 that the recipient device 330 attempted to forward the message, at 380.

In other instances, the recipient device 330 may not be operable to notify the access control server 320 when an email is forwarded. For example, where the recipient device 330 attempts to forward the message at 380 via a third party mail client or webmail interface, signal 382 may not be sent. In such an instance, the recipient of the forwarded message 380 (not shown) may receive an email containing information similar or identical to information included in signal 360. As described above, the information represented in signal 360, however, may not include the message content 415, attachment 420 and/or an identity of the sender 410. The information represented in signal 360 may include an instruction to access the access control server 320. Thus, the recipient of the forwarded message may attempt to access the access control server 320. The access control server 320 can be operable to verify the identity of the recipient of the forwarded message. In the event the recipient of the forwarded message is not an approved recipient, the access control server 320 may not provide message content and/or sender identity information to the recipient of the forwarded message. Furthermore, the access control server 320 may send signal 384 to notify the sender device 310 that an unintended recipient received a forwarded message, for example, from the recipient device 330.

While various embodiments have been described above, it should be understood that they have been presented by way of example only, and not limitation. Although various embodiments have been described as having particular features and/or combinations of components, other embodiments are possible having a combination of any features and/or components from any of embodiments where appropriate as well as additional features and/or components. For example, some embodiments describe a communication channel such that message content and/or sender identity can be substantially continuously refreshed. It should be understood that the sender can set an expiration timer for the message content and/or the sender identity such that the communication channel is closed and/or the message content and/or sender identity are otherwise caused to cease to be presented upon the expiration of the timer. U.S. Patent Application Pub. No. 2015/0096042 entitled “Method and Apparatus for Improved Private Messaging,” the disclosure of which is hereby incorporated by reference in its entirety, includes further disclosure of expiring messages and similar technique that may be used in conjunction with methods and apparatus described herein.

For example, some embodiments described herein relate to the user of a sender device setting permissions for a message. It should be understood that such permissions can be enforced and/or violations of such permissions can be reported by recipient device(s) and/or servers. For example, in an instance where the user of the sender device prohibits forwarding of messaging, an application configured to retrieve the message content executing on a processor of a recipient device may disable forwarding functionality. In addition or alternatively, such an application may report when the user of the recipient device attempts to forward a message. In some instances, however, the recipient device may be operable to access message content and/or sender identity without such trusted software. In such an instance, a server (e.g., an access control server) can be operable to detect and/or report breaches of permissions based on, for example, unknown recipient devices attempting to access the message, which may indicate that the message was forwarded without permission. Thus, in instances where the recipient device is not trusted, a server (e.g., an access control server) can detect and/or report breaches of permissions.

Furthermore, although certain methods, events and/or signals are described as occurring in a particular order, it should be understood that such methods, events, and/or signals can occur in any order, unless the description clearly indicates otherwise.

Some embodiments describe various components of computing entities, such as processors and memories. It should be understood that computing entities may include additional elements, such as network adaptors, input/output modules, and or any other suitable hardware and/or software (stored in memory and/or executing on the processor) to perform any of functions described herein and/or any other suitable function.

Where signal diagrams are described, it should be understood that any device(s) can engage in a method including sending and/or receiving described communications. Where methods are described, it should be understood that the methods can be stored as code in a non-transitory computer readable medium (e.g., a memory). Such code can be configured to cause a processor to execute the method and/or cause the processor to bring about an event. Similarly stated, where methods are described, it should be understood that the methods can be implemented by a computer. Some embodiments described herein relate to computer-readable medium. A computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes including for example some or all of the processes and methods described above. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as ASICs, PLDs, ROM and RAM devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

What is claimed is:

1. A non-transitory processor readable medium storing code representing instructions configured to be executed by a processor, the code comprising code to cause the processor to:
receive, from a sender device, a portion of a message;
receive, from a recipient device a request to access the portion of the message; and
establish a communication channel with the recipient device in response to the request to access the portion of the message, the communication channel configured such that the recipient device is provided access to the portion of the message while the recipient device sends an indication that a predefined user input is continuously suppled at the recipient device.

2. The non-transitory processor readable medium of claim 1, wherein the predefined user input is not consistent with a user input for saving the portion of the message.

3. The non-transitory processor readable medium of claim 1, the code further comprising code to cause the processor to:
receive, from the recipient device, an indication that the predefined user input is not being supplied; and
close the communication channel in response to receiving the indication that the predefined user input is not being supplied such that access to the portion of the message to the recipient device is revoked.

4. The non-transitory processor readable medium of claim 1, wherein:
the portion of the message is a first portion of the message; and
the code to cause the processor to receive the portion of the message includes code to cause the processor to receive the message,
the code further comprising code to cause the processor to send a second portion of the message to a communication server such that the recipient device receives the second portion of the message via the communication server, the second portion of the message including an instruction to cause the recipient device to request to access the first portion of the message.

5. The non-transitory processor readable medium of claim 1, wherein the portion of the message is a first portion of the message, the code further comprising code to cause the processor to:
receive, from a compute device other than the recipient device, a request to access the first portion of the message; and
send, a signal to the sender device a signal associated with a report that the recipient device forwarded a second portion of the message in response to receiving the request to access the first portion of the message from the compute device.

6. The non-transitory processor readable medium of claim 1, wherein:
the portion of the message is a first portion of the message; and
the communication channel is configured such that the recipient device displays the first portion of the message without displaying a second portion of the message.

7. The non-transitory processor readable medium of claim 6, wherein:
the first portion of the message is at least one of a content portion of the message or an attachment; and
the second portion of the message is received by the recipient device via a communication server.

8. The non-transitory processor readable medium of claim 1, the code further comprising code to cause the processor to:
receive, from the sender device, a signal to revoke access to the portion of the message; and
close the communication channel in response to receiving the signal to revoke access.

9. The non-transitory processor readable medium of claim 1, the code further comprising code to cause the process to store the portion of the message in a memory location, access to the portion of the message provided via an iframe linked to the memory location.

10. The non-transitory processor readable medium of claim 9, the code further comprising code to cause the processor to:
delink the iframe and the memory location such that the recipient device refreshes the iframe and ceases to present the content portion of the message.

11. The non-transitory processor readable medium of claim 1, wherein the communication channel is configured such that the recipient device is provided access to the portion of the message by substantially continuously requesting access to the portion of the message.

12. The non-transitory processor readable medium of claim 1, wherein the communication channel is configured such that the recipient device substantially continuously sends the indication that the predefined input is continuously supplied.

13. A non-transitory processor readable medium storing code representing instructions configured to be executed by a processor, the code comprising code to cause the processor to:
compose a message, the message including a content portion;
define an access control for the content portion of the message, the access control including an indication to impede copying of the content portion of the message;
send a signal representing the content portion of the message and the access control, to an access control server, such that a recipient device retrieves the content portion of the message from the access control server via a communication channel such and is provided access to the portion of the message while the recipient device sends an indication that a predefined user input is continuously suppled.

14. The non-transitory processor readable medium of claim 13, the code further comprising code to cause the processor to:
send a signal to a communication server such that the recipient device receives, via the communication server, an instruction to access the content portion of the message from the access control server.

15. The non-transitory processor readable medium of claim 13, the code further comprising code to cause the processor to:
send a signal representing a message, to the access control server, such that the access control server sends a signal to a communication server and the recipient device receives, via the communication server, an instruction to access the content portion of the message from the access control server.

16. A non-transitory processor readable medium storing code representing instructions configured to be executed by a processor, the code comprising code to cause the processor to:
receive, from a communication server, a message including an instruction to access a portion of the message via an access control server; and
establish a communication channel with the access control server, in response to receiving the instruction to access the content portion of the message, the communication channel configured such that the content portion is presented while an indication that a predefined user input is sent to the access control server.

17. The non-transitory processor readable medium of claim 16, the code further comprising code to cause the processor to:
receive, from an input device, a signal associated with the predefined user input,
the indication that the predefined user input is sent to the access control server in response to receiving the signal from the input device.

18. The non-transitory processor readable medium of claim 17, the code further comprising code to cause the processor to:
receive, from the input device, a signal associated with an input additional to the predefined user input; and
send, to the access control server, an indication of the input additional to the predefined user input such that the access control server ceases to provide access to the content portion of the message in response to the user input additional to the predefined user input.

19. The non-transitory processor readable medium of claim 16, wherein the communication channel is configured such that the content portion of the message is presented without simultaneously presenting an indication of the sender of the message.
